(19) United States
(12) Patent Application Publication
(10) Pub. No.: US 2018/0182516 A1
(43) Pub. Date: Jun. 28, 2018

(54) RARE EARTH MAGNET

(71) Applicant: TOYOTA JIDOSHA KABUSHIKI KAISHA, Toyota-shi (JP)

(72) Inventors: Masaaki ITO, Susono-shi (JP); Noritsugu SAKUMA, Mishima-shi (JP); Masao YANO, Suntou-gun (JP); Hidefumi KISHIMOTO, Susono-shi (JP); Tetsuya SHOJI, Susono-shi (JP)

(73) Assignee: TOYOTA JIDOSHA KABUSHIKI KAISHA, Toyota-shi (JP)

(21) Appl. No.: 15/846,343

(22) Filed: Dec. 19, 2017

(30) Foreign Application Priority Data
Dec. 28, 2016 (JP) 2016-256788

(51) Int. Cl. H01F 1/058; C22C 38/16; C22C 38/06; C22C 38/00

(52) U.S. Cl. CPC H01F 1/058; C22C 38/16; C22C 2202/02; C22C 38/005; C22C 38/002; C22C 38/06

(57) ABSTRACT

To provide an R—Fe—B-based rare earth magnet where R is mainly Ce, ensuring that even when a rare earth element R¹ except for Ce is very small in amount or is not present, the coercive force can be enhanced.

A rare earth magnet wherein the rare earth magnet has a total composition represented by the formula: CeₚR¹_{q}T_{(100-p-q-r-s)}BᵣM¹ₛ (wherein R¹ is a rare earth element except for Ce, T is one or more members selected from Fe, Ni and Co, M¹ is one or more members selected from Ti, Ga, Zn, Si, Al, Nb, Zr, Mn, V, W, Ta, Ge, Cu, Cr, Hf, Mo, P, C, Mg, Hg, Ag, and Au, and an unavoidable impurity, and p, q, r, and s are 11.80≤p≤12.90, 0≤q≤3.00, 5.00≤r≤20.00, and 0≤s≤3.00), and wherein the rear earth magnet comprises a magnetic phase and a (Ce,R¹)-rich phase present around the magnetic phase.

### TECHNICAL FIELD

The present disclosure relates to an R—Fe—B-based rare earth magnet (R is a rare earth element). More specifically, the present disclosure relates to an R—Fe—B-based rare earth magnet in which R is mainly Ce.

### BACKGROUND ART

An R—Fe—B-based rear earth magnet is a high-performance magnet having excellent magnetic properties and is therefore used for a motor constituting a hard disk, MRI (magnetic resonance imaging) device, etc. and in addition, used for a driving motor of a hybrid vehicle, an electric vehicle, etc.

A rare earth magnet where R is Nd, i.e., an Nd—Fe—B-based rare earth magnet, is most representative of the R—Fe—B-based rare earth magnet. However, the price of Nd is rising, and it is being attempted to replace part of Nd in the Nd—Fe—B-based rare earth magnet by Ce, La, Gd, Y and/or Sc, which are less expensive than Nd.

Patent Document 1 discloses an (Nd,Ce)—Fe—B-based rare earth magnet where Ce is substituted for part of Nd of an Nd—Fe—B-based rare earth magnet.

### RELATED ART

### Patent Document

[Patent Document 1] Japanese unexamined patent publication) No. 2016-111136 (JP 2016-111136 A)

### SUMMARY OF THE INVENTION

### Problems to be Solved by the Invention

The (Nd,Ce)—Fe—B-based rare earth magnet disclosed in Patent Document 1 contains from 1.25 to 20.00 at % of Nd, and studies are not sufficiently made on enhancement of the magnetic properties, particularly the coercive force, when Nd is very small in content or is not present.

Under these circumstances, the present inventors have found that the R—Fe—B-based rare earth magnet where R is mainly Ce has room for improvement of the coercive force when a rare earth element R¹ except for Ce is very small in amount or is not present.

The present disclosure has been made to solve the task above. An object of the present disclosure is to provide an R—Fe—B-based rare earth magnet where R is mainly Ce, ensuring that even when a rare earth element R¹ except for Ce is very small in amount or is not present, the coercive force can be enhanced.

### Means to Solve the Problems

The present inventors have made many intensive studies to attain the object above and accomplished the rare earth magnet of the present disclosure. The gist thereof is as follows.

<1> A rare earth magnet

wherein the rare earth magnet has a total composition represented by the formula: CeₚR¹_{q}T_{(100-p-q-r-s)}BᵣM¹ₛ (wherein R¹ is a rare earth element except for Ce, T is one or more elements selected from Fe, Ni and Co, M¹ is one or more elements selected from Ti, Ga, Zn, Si, Al, Nb, Zr, Mn, V, W, Ta, Ge, Cu, Cr, Hf, Mo, P, C, Mg, Hg, Ag, and Au, and an unavoidable impurity, and

p, q, r, and s are

11.80≤p≤12.90,

0≤q≤3.00,

5.00≤r≤20.00, and

0≤s≤3.00), and

wherein the rare earth magnet comprises

a magnetic phase and

a (Ce,R¹)-rich phase present around the magnetic phase.

<2> The rare earth magnet according to item <1>, wherein the p is 11.80≤p≤12.20.

<3> The rare earth magnet according to item <1> or <2>, wherein the q is 0≤q≤2.00.

<4> The rare earth magnet according to item <1> or <2>, wherein the q is 0≤q≤1.00.

<5> The rare earth magnet according to any one of items <1> to <4>, wherein the volume fraction of the magnetic phase is from 85.00 to 96.20%.

<6> The rare earth magnet according to any one of items <1> to <5>, wherein the R¹ is one or more members selected from Nd, Pr, Dy, and Tb.

<7> The rare earth magnet according to any one of items <1> to <6>, wherein the T is Fe.

### Effects of the Invention

According to the present disclosure, the Ce content is specified in a predetermined range, and a rare earth magnet ensuring that the coercive force can be enhanced even when a rare earth element R¹ except for Ce is very small in content or is not present, can thereby be provided.

### BRIEF DESCRIPTION OF THE DRAWINGS

FIG. 1 is a diagram schematically illustrating the structure of the rare earth magnet of the present disclosure.

FIG. 2 is a graph illustrating the relationship between the Ce content and the coercive force.

FIG. 3 is a graph illustrating the relationship between the volume fraction of magnetic phase and the magnetization.

### MODE FOR CARRYING OUT THE INVENTION

The embodiments of the rare earth magnet according to the present disclosure are described in detail below. The embodiments described below should not be construed to limit the rare earth magnet according to the present disclosure.

In the present description, with respect to an R—Fe—B-based rare earth magnet where R is mainly Ce, a rare earth magnet where a rare earth element R¹ except for Ce is very small in content or it is not present is sometimes referred to as a (Ce,R¹)—Fe—B-based rare earth magnet.

The (Ce,R¹)—Fe—B-based rare earth magnet is obtained by liquid quenching, etc. of a molten (Ce,R¹)—Fe—B-based alloy. A magnetic phase represented by (Ce,R¹)₂Fe₁₄B (hereinafter, such a phase is sometimes referred to as “(Ce,R¹)₂Fe₁₄B phase”) is formed by the liquid quenching, etc. In the residual liquid after the (Ce,R¹)₂Fe₁₄B phase is formed, a (Ce,R¹)-rich phase is formed by excess Ce and R¹ which not contribute to the formation of the (Ce,R¹)₂Fe₁₄B phase respectively. The (Ce,R¹)-rich phase is present around the (Ce,R¹)₂Fe₁₄B phase. The (Ce,R¹)-rich phase is formed by elements not contributing to the formation of the (Ce,R¹)₂Fe₁₄B phase and has a high concentrations of Ce and R¹.

In the (Ce,R¹)—Fe—B-based rare earth magnet, if the entirety is a (Ce,R¹)₂Fe₁₄B phase, the total content of Ce and R¹ is roughly 11.8 at %. Assuming that the total content of Ce, R¹, Fe and B is 100 at %, the total content of Ce and R¹ is roughly 11.8 (=2/(2+14+1)*100) at %.

If the total content (at %) of Ce and R¹ is small, the proportion of the (Ce,R¹)-rich phase decreases. The (Ce,R¹)-rich phase magnetically separates (Ce,R¹)₂Fe₁₄B phases from each other and contributes to enhancement of the coercive force of the (Ce,R¹)—Fe—B-based rare earth magnet.

Usually, when the rare earth-rich phase is decreased, the coercive force of the rare earth magnet lowers. However, the present inventors have found that in the case of a (Ce,R¹)—Fe—B-based rare earth magnet, even when the (Ce,R¹)-rich phase is decreased, i.e., the total content (at %) of Ce and R¹ is small, the coercive force does not lower.

The configuration of the rare earth magnet according to the present disclosure based on the finding above is described below.

### (Total Composition)

The total composition of the rare earth magnet of the present disclosure is represented by the formula: CeₚR¹_{q}T_{(100-p-q-r-s)}BᵣM¹ₛ. In the formula, R¹ is a rare earth element except for Ce. T is one or more elements selected from Fe, Ni and Co. M¹ is one or more elements selected from Ti, Ga, Zn, Si, Al, Nb, Zr, Mn, V, W, Ta, Ge, Cu, Cr, Hf, Mo, P, C, Mg, Hg, Ag, and Au, and an unavoidable impurity.

p is the content of Ce, q is the content of R¹, r is the content of B (boron), s is the content of M¹, and each of the values p, q, r and s is at %. Respective contents of Ce, R¹, B and M¹ are described below.

### (Ce)

In the (Ce,R¹)—Fe—B-based rare earth magnet, when the content p of Ce is from 11.80 to 12.90 at %, the coercive force can be enhanced. From the viewpoint of enhancing the coercive force, the content p of Ce is preferably 12.20 at % or less.

Not wishing to be bound by theory, R¹ in the R¹-rich phase is considered to be often present by itself without bonding to Fe, etc. On the other hand, it is considered that Ce in the Ce-rich phase is present in the state of being bonded to Fe, etc. and as a result, compared with the R¹-rich phase, the Ce-rich phase exhibits an excellent effect of magnetically separating magnetic phases from each other even when the amount thereof is small. For this reason, the content of R¹ in the (Ce,R¹)-rich phase is preferably as small as possible.

### (R¹)

When the content q of R¹ in the total composition is small, the content of R¹ in the (Ce,R¹)-rich phase is small as well. When the content q of R¹ in the total composition is 3.00 at % or less, the coercive force is not lowered. From this point of view, the content q of R¹ is preferably 2.00 at % or less, more preferably 1.00 at % or less, and is ideally 0 at %. On the other hand, the content q of R¹ is preferably 0.10 at % or more.

R¹ may be one or more elements selected from Nd, Pr, Dy and Tb, and the content of Nd may be 90.00 at % or more relative to the entire R¹.

### (B)

When the content r of B is 5.0 at % or more, the amount of an amorphous structure remaining inside a ribbon, etc., at the time of liquid quenching is not 10.00 vol % or more relative to the entire rare earth magnet. On the other hand, when the content r of B is 20.00 at % or less, B forming no solid solution with Fe does not remain excessively in the (Ce,R¹)-rich phase. From this point of view, the content r of B is preferably 10.00 at % or less, more preferably 8.00 at % or less.

### (M¹)

M¹ may be contained within a range not impairing the properties of the rare earth magnet of the present disclosure. M¹ may contain an unavoidable impurity. The unavoidable impurity indicates an impurity that is unavoidably contained or causes a significant rise in the production cost for avoiding its inclusion, such as impurity contained in a raw material. When the content s of M¹ is 3.00 at % or less, the properties of the rare earth magnet of the present disclosure are not degraded. The content s of M¹ is preferably 2.00 at % or less and is ideally 0. However, excessively decreasing the content s of M¹ is accompanied by a rise in the production cost, and therefore the content s of M¹ is preferably 0.10 at % or more.

### (T)

T is classified into an iron group element, and Fe, Ni and Co have in common a property of exhibiting ferromagnetism at normal temperature and normal pressure. Accordingly, these may be interchanged with each other. When Co is contained, the magnetization is improved, and the Curie point increases. This effect is exhibited at a Co content of 0.10 at % or more. From this point of view, the content of Co is preferably 0.10 at % or more, more preferably 1.00 at % or more, still more preferably 3.00 at % or more. On the other hand, since Co is expensive and Fe is less expensive, in view of profitability, the content of Fe is preferably 80.00 at % or more, more preferably 90.00 at % or more, relative to the entire T, and the entirety of T may be Fe.

### (Magnetic Phase and (Ce,R¹)-Rich Phase)

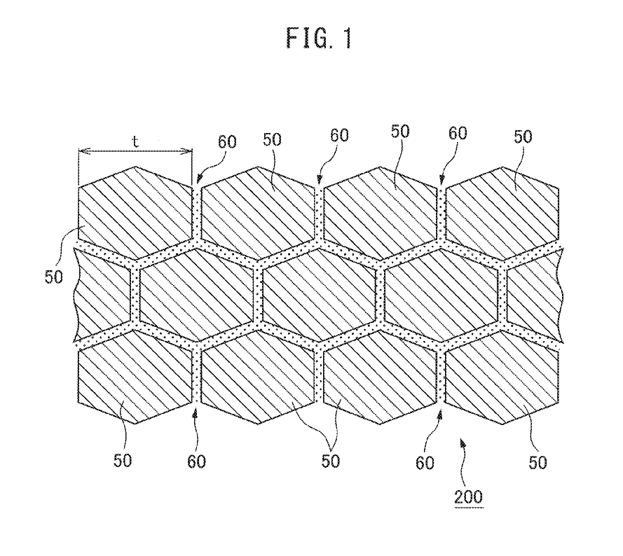

The structure of the rare earth magnet of the present disclosure having a composition represented by the formula above is described below. FIG. 1 is a diagram schematically illustrating the structure of the rare earth magnet of the present disclosure. The rare earth magnet 200 has a magnetic phase 50 and a (Ce,R¹)-rich phase 60. The magnetic phase 50 has a grain shape. The (Ce,R¹)-rich phase 60 is present around the magnetic phase 50. The (Ce,R¹)-rich phase 60 magnetically separates magnetic phases 50 from each other and enhances the coercive force of the rare earth magnet 200.

From the viewpoint of ensuring the coercive force, the average grain size of the magnetic phase 50 is preferably 1,000 nm or less, more preferably 500 nm or less.

The “average grain size” indicates, for example, an average value of lengths t in the longitudinal direction of magnetic phases 50 illustrated in FIG. 1. For example, a certain region is defined in a scanning electron micrograph or transmission electron micrograph of the rare earth magnet 200, and an average value of respective lengths t of the magnetic phases 50 present within the certain region is calculated and taken as the “average grain size”. In the case where the cross-sectional shape of the magnetic phase 50 is elliptic, the long axis is taken as the length t. In the case where the cross-section of the magnetic phase 50 is quadrilateral in shape, the longer diagonal line is taken as the length t.

The rare earth magnet 200 may comprise a phase (not shown) other than the magnetic phase 50 and the (Ce,R¹)-rich phase 60. The phase other than the magnetic phase 50 and the (Ce,R¹)-rich phase 60 includes an oxide, a nitride, an intermetallic compound, etc.

The properties of the rare earth magnet 200 are exerted mainly by the magnetic phase 50 and the (Ce,R¹)-rich phase 60. Most of the phases other than the magnetic phase 50 and the (Ce,R¹)-rich phase 60 are an impurity. Accordingly, the total content of the magnetic phase 50 and the (Ce,R¹)-rich phase 60 relative to the rare earth magnet 200 is preferably 95.00 vol % or more, more preferably 97.00 vol % or more, still more preferably 99.00 vol % or more.

### (Volume Fraction of Magnetic Phase)

An R—Fe—B-based rare earth magnet is used as an anisotropic magnet in many cases. The same holds for the (Ce,R¹)—Fe—B-based rare earth magnet.

When anisotropy is imparted to the rare earth magnet 200, until up to a volume fraction of the magnetic phase 50 of 96.20%, as the content of the magnetic phase 50 increases, the magnetization increases. In order for the rare earth magnet 200 to have practical magnetization, the volume fraction of the magnetic phase 50 is preferably 85.00% or more. From this point of view, the volume fraction of the magnetic phase 50 is more preferably 90.00% or more, still more preferably 92.30% or more.

However, if the volume fraction of the magnetic phase 50 exceeds 96.20%, the magnetization drastically decreases.

In order to impart anisotropy to the (Ce,R¹)—Fe—B-based rare earth magnet, for example, the entire rare earth magnet 200 is subjected to severe hot working. In the (Ce,R¹)-rich phase, the total concentration of Ce and R¹ is high, and therefore the melting point thereof is low. As a result, the (Ce,R¹)-rich phase slightly melts during sever hot working.

On the other hand, the magnetic phase 50 rotates in easy axis direction of magnetization (c axis direction) while grains of the magnetic phase 50 are being grown. At this time, the slightly melted (Ce,R¹)-rich phase acts like a lubricant for lubricating the rotation of the magnetic phase 50. If the volume fraction of the magnetic phase 50 exceeds 96.20%, the volume fraction of the (Ce,R¹)-rich phase acting like a lubricant is reduced, and this makes it difficult for the magnetic phase 50 to rotate. As a result, the magnetic phase 50 is not oriented in easy axis direction of magnetization (c axis direction), and magnetization drastically decreases. For these reasons, the volume fraction of the magnetic phase 50 is preferably 96.20% or less.

The volume fraction of the magnetic phase 50 is determined as follows. The content of each of Ce, Fe and B in the rare earth magnet 200 is measured using a high-frequency inductively coupled plasma emission spectrometry. These contents are converted from the value of mass percentage to the value of atomic percentage, and the obtained values are substituted into the equation based on a ternary Ce—Fe—B phase diagram in atomic percentages to calculate the volume fraction of the magnetic phase 50. The volume fraction of the magnetic phase 50 is a volume percentage assuming the entire rare earth magnet 200 is 100 vol %.

### (Production Method)

The method for producing the rare earth magnet of the present disclosure is described below.

An alloy having a total composition represented by the formula CeₚR¹_{q}T_{(100-p-q-r-s)}BᵣM¹ₛ is prepared. R¹, T, M¹, p, q, r, and s are as described above.

The rare earth magnet of the present disclosure may be a magnetic powder or a sintered body of the magnetic powder or may also be a plastic formed body obtained by applying severe hot working to the sintered body.

As to the production method of the magnetic powder, a known method can be employed. The method includes, for example, a method of obtaining an isotropic magnetic powder having a nanocrystalline structure by a liquid quenching method, or a method of obtaining an isotropic or anisotropic magnetic powder by an HDDR (Hydrogen Disproportionation Desorption Recombination) method.

The method of obtaining a magnetic powder having a nanocrystalline structure by a liquid quenching method is roughly described. An alloy having the same composition as the total composition of the rare earth magnet 200 is melted by high-frequency melting to prepare a molten alloy. For example, the molten alloy is ejected on a copper-made single roll in an Ar gas atmosphere under reduced pressure of 50 kPa or less to prepare a quenched ribbon. This quenched ribbon is pulverized, for example, to 10 μm or less.

The conditions in liquid quenching when using a copper-made single roll may be appropriately determined such that the obtained ribbon has a nanocrystalline structure.

The molten alloy ejection temperature may be typically 1,300° C. or more, 1,350° C. or more, or 1,400° C. or more, and may be 1,600° C. or less, 1,550° C. or less, or 1,500° C. or less.

The peripheral velocity of the single roll may be typically 20 m/s or more, 24 m/s or more, or 28 m/s or more, and may be 40 m/s or less, 36 m/s or less, or 32 m/s or less.

Next, the method for obtaining the sintered body is roughly described. The magnetic powder obtained by pulverization is subjected to magnetic field orientation, and a sintered boy having anisotropy is obtained via liquid phase sintering. Alternatively, a sintered body having isotropy is obtained by sintering a magnetic powder having an isotropic nanocrystalline structure; a plastic formed body having anisotropy is obtained by sintering a magnetic power having an isotropic nanocrystalline structure and further subjecting the sintered body to severe working; or a sintered body having isotropy or anisotropy is obtained by sintering a magnetic powder having isotropy or anisotropy obtained by an HDDR method.

In the case of obtaining a plastic formed body having anisotropy by sintering a magnetic power having an isotropic nanocrystalline structure and further subjecting the sintered body to severe working, the conditions in each step may be appropriately determined so that a desired plastic formed body can be obtained.

The pressure at the time of sintering may be 200 MPa or more, 300 MPa or more, or 350 MPa or more, and may be 600 MPa or less, 500 MPa or less, or 450 MPa or less.

The sintering temperature may be 550° C. or more, 600° C. or more, or 630° C. or more, and may be 750° C. or less, 700° C. or less, or 670° C. or less.

The pressurization time during sintering may be 2 seconds or more, 3 seconds or more, or 4 seconds or more, and may be 8 seconds or less, 7 seconds or less, or 6 seconds or less.

The temperature at the time of severe working of the sintered body may be 650° C. or more, 700° C. or more, or 720° C. or more, and may be 850° C. or less, 800° C. or less, or 770° C. or less.

The strain rate at the time of severe working of the sintered body may be 0.01/s or more, 0.1/s or more, 1.0/s or more, or 3.0/s or more, and may be 15.0/s or less, 10.0/s or less, or 5.0/s or less.

The method for severe working of the sintered body includes upsetting, backward extrusion, etc.

### EXAMPLES

The rare earth magnet of the present disclosure is described more specifically below by referring to Examples. The rare earth magnet of the present disclosure is not limited to the conditions employed in the following Examples.

### (Preparation of Sample)

An alloy having the composition shown in Table 1 was prepared. A melt of the alloy was subjected to liquid quenching by a single roll method to obtain a ribbon. The conditions in liquid quenching were a molten alloy temperature (ejection temperature) of 1,450° C. and a roll peripheral velocity of 30 m/s. The liquid quenching was performed in a reduced-pressure argon gas atmosphere. It was confirmed by transmission electron microscope (TEM) observation that the ribbon has a nanocrystalline structure.

The ribbon was coarsely ground to prepare a powder, and the powder was charged into a die and pressurized/heated to obtain a sintered body. The pressurizing and heating conditions were an applied pressure of 400 MPa, a heating temperature of 650° C., and a pressurization and heating holding time of 5 seconds.

The sintered body was hot upset (severe hot working) to obtain a rare earth magnet 200 (plastic formed body). The hot upsetting conditions were a working temperature of 750° C. and a strain rate of 0.1 to 10.0/s. It was confirmed by a scanning electron microscope (SEM) that the ribbon has an oriented nanocrystalline structure.

### (Evaluations)

Each sample was measured for the coercive force and the magnetization. The measurement was performed at normal temperature by using a Vibrating Sample Magnetometer (VSM) manufactured by Lake Shore.

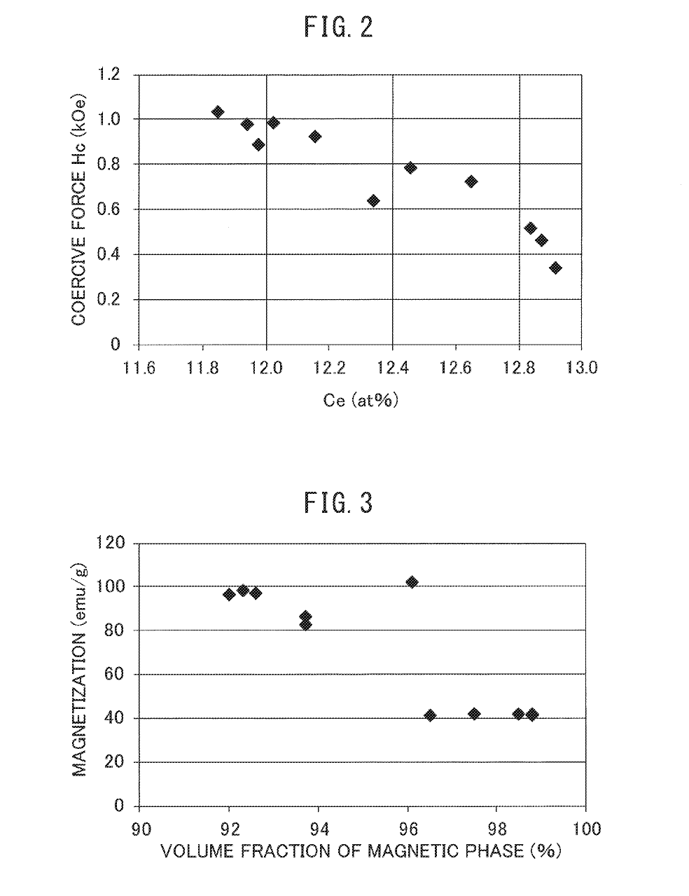

The evaluation results are shown in Table 1 and FIGS. 2 and 3. FIG. 2 is a graph illustrating the relationship between the Ce content and the coercive force in each sample. FIG. 3 is a graph illustrating the relationship between the volume fraction of magnetic phase and the magnetization in each sample. In the column showing the content (at %) of Nd in Table 1, “-” indicates that the content is not more than the measurement limit. The measurement limit of Nd is 0.01 at % or less.

TABLE 1

| | | | | | | | | Volume | Coercive | Magnet- |
|---|---|---|---|---|---|---|---|---|---|---|
| | | | | | | | | Fraction of | Force | ization |
| | Total Composition (at %) | | | | | | | Magnetic | Hc | Br |
| | Ce | Nd | Fe | B | Ga | Cu | Al | Phase (%) | (kOe) | (eum/g) |
| Example 1 | 12.46 | — | 81.17 | 5.72 | 0.40 | 0.10 | 0.14 | 96.10 | 0.78 | 102.10 |
| Example 2 | 12.87 | — | 80.73 | 5.70 | 0.39 | 0.10 | 0.21 | 93.70 | 0.46 | 82.40 |
| Example 3 | 12.84 | — | 80.21 | 6.20 | 0.40 | 0.11 | 0.24 | 92.60 | 0.52 | 97.20 |
| Example 4 | 12.65 | — | 79.87 | 6.81 | 0.39 | 0.11 | 0.16 | 92.30 | 0.72 | 98.30 |
| Example 6 | 12.34 | — | 81.21 | 5.54 | 0.41 | 0.12 | 0.38 | 93.70 | 0.64 | 86.50 |
| Example 7 | 12.15 | — | 81.33 | 5.93 | 0.37 | 0.10 | 0.12 | 97.50 | 0.92 | 41.60 |
| Example 8 | 11.98 | — | 81.54 | 5.86 | 0.37 | 0.11 | 0.14 | 98.80 | 0.89 | 41.50 |
| Example 9 | 11.94 | — | 81.51 | 5.91 | 0.39 | 0.13 | 0.12 | 98.80 | 0.98 | 41.70 |
| Example 10 | 11.85 | — | 81.29 | 6.30 | 0.37 | 0.10 | 0.09 | 98.50 | 1.03 | 41.60 |
| Example 11 | 12.02 | — | 81.66 | 5.69 | 0.40 | 0.11 | 0.12 | 96.50 | 0.99 | 41.50 |
| Comparative | 12.91 | — | 80.94 | 5.47 | 0.38 | 0.11 | 0.19 | 92.00 | 0.34 | 96.70 |
| Example 1 | | | | | | | | | | |

As seen from Table 1 and FIGS. 2 and 3, it was confirmed that in a rare earth magnet where the content of Ce is from 11.80 to 12.90 at %, a coercive force of 0.40 kOe or more is obtained and that in a rare earth magnet where the volume fraction of the magnetic phase is from 92.30 to 92.60%, a magnetization of 80.00 emu/g or more is obtained. In addition, FIG. 3 suggests that in the region where the volume fraction of the magnetic phase is 96.2% or less, the reduction of magnetization is made gentle due to decrease in the volume faction of the magnetic phase. It is therefore believed that when the volume fraction of the magnetic phase is 85.00% or more, a magnetization of 80.00 emu/g or more can be ensured.

The effects of the present invention could be confirmed from these results.

### DESCRIPTION OF NUMERICAL REFERENCES

50 Magnetic phase
60 (Ce,R¹)-rich phase
200 Rare earth magnet

What is claimed is:

1. A rare earth magnet
wherein the rare earth magnet has a total composition represented by the formula: CeₚR¹_{q}T_{(100-p-q-r-s)}BᵣM¹ₛ (wherein R¹ is a rare earth element except for Ce, T is one or more elements selected from Fe, Ni and Co, M¹ is one or more elements selected from Ti, Ga, Zn, Si, Al, Nb, Zr, Mn, V, W, Ta, Ge, Cu, Cr, Hf, Mo, P, C, Mg, Hg, Ag, and Au, and an unavoidable impurity, and
p, q, r, and s are
11.80≤p≤12.90,
0≤q≤3.00,
5.00≤r≤20.00, and
0≤s≤3.00), and
wherein the rare earth magnet comprises
a magnetic phase and
a (Ce,R¹)-rich phase present around the magnetic phase.

2. The rare earth magnet according to claim 1, wherein the p is 11.80≤p≤12.20.

3. The rare earth magnet according to claim 1, wherein the q is 0≤q≤2.00.

4. The rare earth magnet according to claim 1, wherein the q is 0≤q≤1.00.

5. The rare earth magnet according to claim 1, wherein the volume fraction of the magnetic phase is from 85.00 to 96.20%.

6. The rare earth magnet according to claim 1, wherein the R¹ is one or more elements selected from Nd, Pr, Dy, and Tb.

7. The rare earth magnet according to claim 1, wherein the T is Fe.

8. The rare earth magnet according to claim 2, wherein the q is 0≤q≤2.00.

9. The rare earth magnet according to claim 2, wherein the q is 0≤q≤1.00.

10. The rare earth magnet according to claim 2, wherein the volume fraction of the magnetic phase is from 85.00 to 96.20%.

11. The rare earth magnet according to claim 3, wherein the volume fraction of the magnetic phase is from 85.00 to 96.20%.

12. The rare earth magnet according to claim 4, wherein the volume fraction of the magnetic phase is from 85.00 to 96.20%.

13. The rare earth magnet according to claim 2, wherein the R¹ is one or more elements selected from Nd, Pr, Dy, and Tb.

14. The rare earth magnet according to claim 3, wherein the R¹ is one or more elements selected from Nd, Pr, Dy, and Tb.

15. The rare earth magnet according to claim 4, wherein the R¹ is one or more elements selected from Nd, Pr, Dy, and Tb.

16. The rare earth magnet according to claim 5, wherein the R¹ is one or more elements selected from Nd, Pr, Dy, and Tb.
